(19) United States
(12) Patent Application Publication
(10) Pub. No.: US 2016/0293065 A1
(43) Pub. Date: Oct. 6, 2016

(54) M Piece

(71) Applicant: Darryl Cunningham, SR., Birmingham, AL (US)

(72) Inventor: Darryl Cunningham, SR., Birmingham, AL (US)

(21) Appl. No.: 14/545,130

(22) Filed: Mar. 30, 2015

(51) Int. Cl. G09F 7/00; G09F 13/00

(52) U.S. Cl. CPC G09F 7/00; G09F 13/00

(57) ABSTRACT

The M Piece is a cover that prevents the mouth of the wearer of a headset (Coaches, Announcers or Speakers) to be seen by others from a frontal and side view. It is made up of a manual and electronic version. The metal bar frame is attached to the Acrylic sign holder (Manual) or the Protective case (Digital) with brackets and screws and is attached to the headset. The card stock can be placed manually into the Manual Version. The Digital flat screen is securely inside of the protective case for digital transmission. The design allows it to be attachable to any headset.

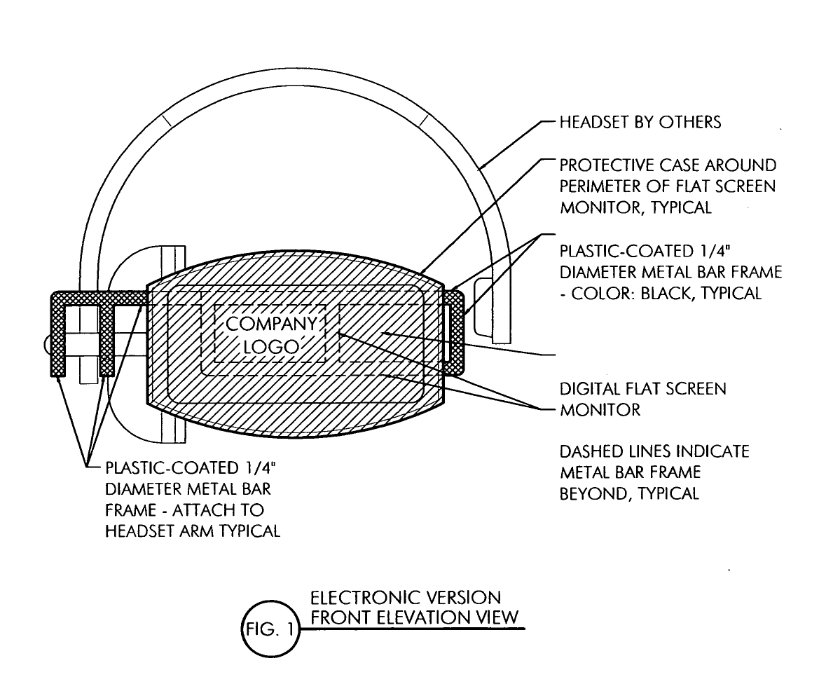

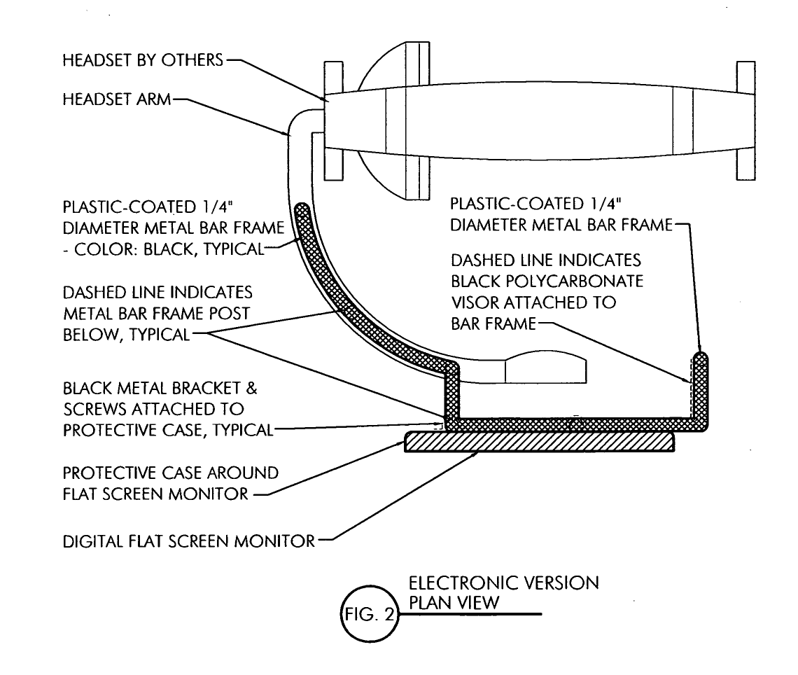

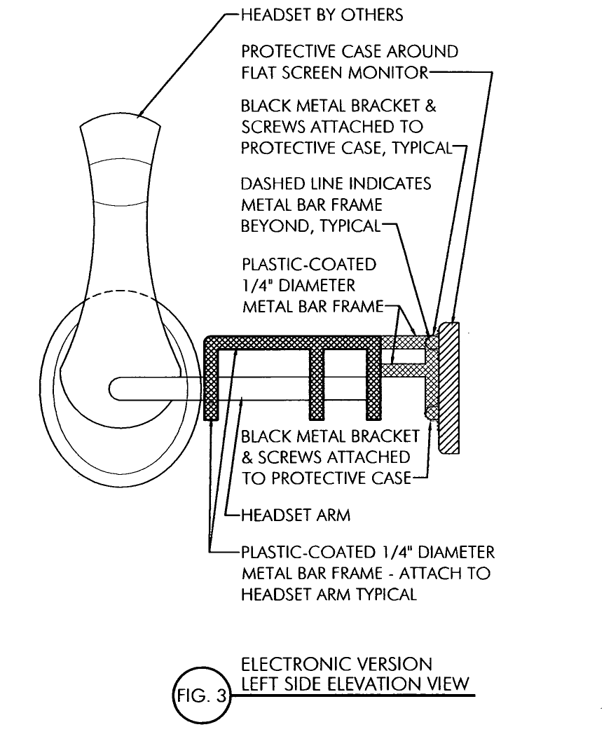

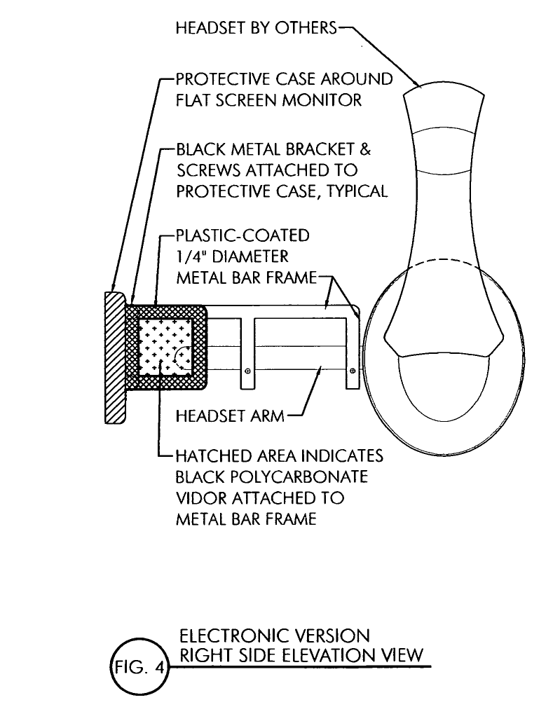

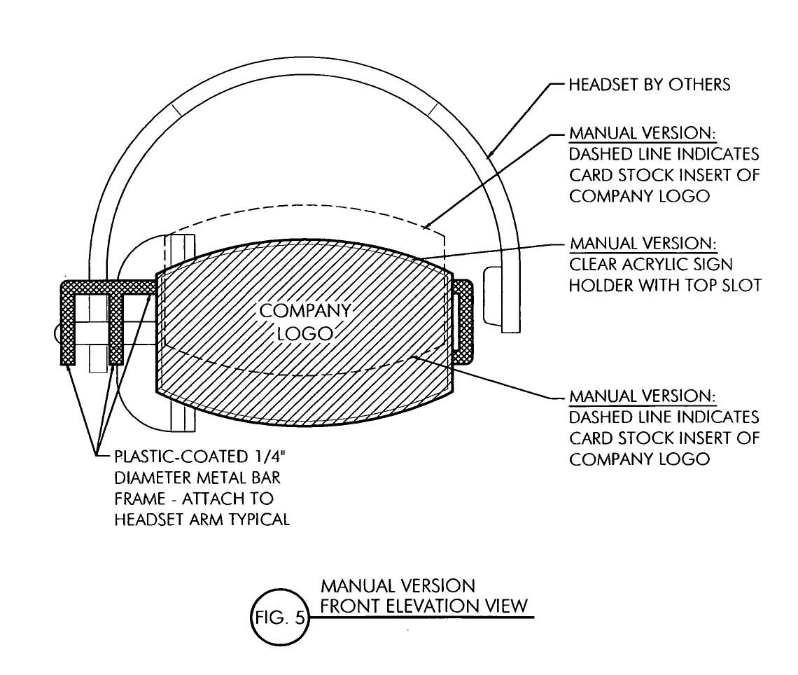

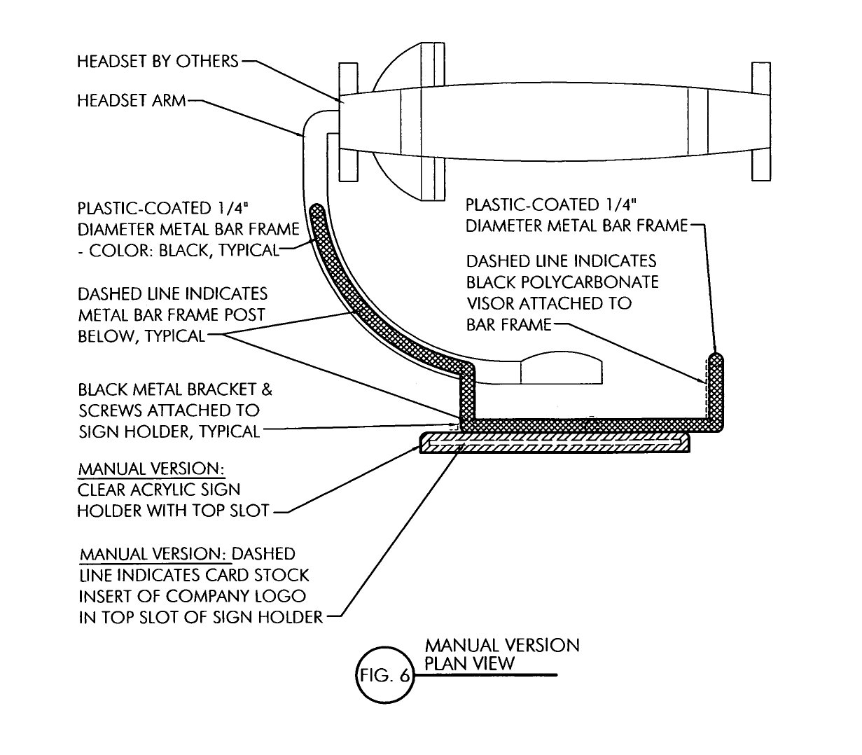

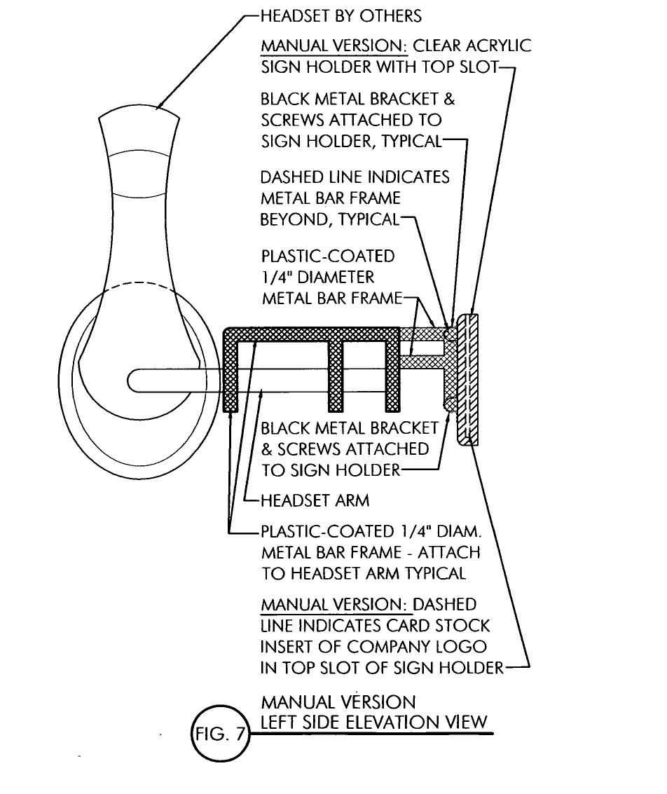

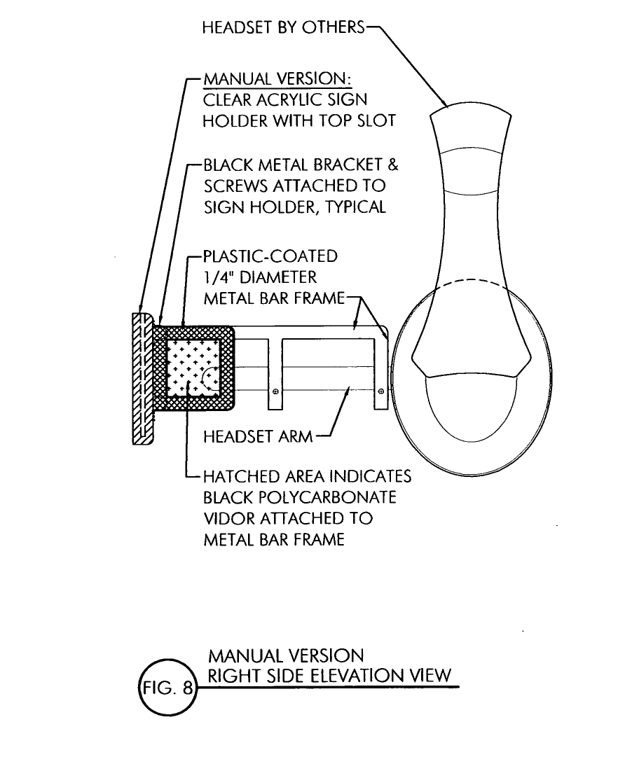

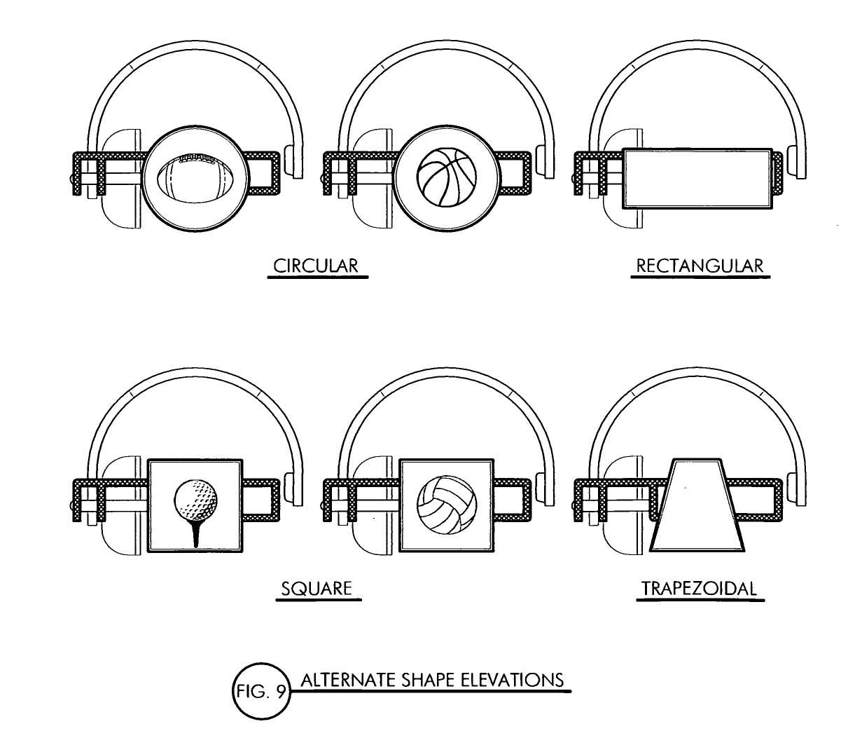

### CROSS REFERENCE TO RELATED APPLICATIONS

I did not receive any federally sponsored research or development funds.

I did not have any joint research partners with this invention.

Reference to a Sequence listing is not applicable with this invention.

The statement which includes any prior disclosures is revealed in the non-provisional application which was filed on Aug. 4, 2014, which received the application No. 61/999,679.

The background statement of the invention is as follows. The M Piece was conceived out of the need to protect the coach's plays that are called in from the sidelines by the coaching staff. The coaches normally have to cover their mouth with a clipboard or some other paper or playbook in order to protect their lips from being read by the opposing team.

A brief description of the invention states that the M Piece covers the mouth so that the plays can't be interpreted by the opposing team which could gain a great advantage with this information. The M Piece can also generate income by using the cover as a advertising piece by sponsors of the game. The sponsors can buy highly visible advertisement spots on the M Piece.

The brief description of the sides of the drawing includes the following. Frontal view, right side view, left side view, and top view.

The detailed description of the invention is as follows. The M Piece is a device that can be attached or fitted to any head set that is used by coaches, staff, commentators or any member who wears headsets during any sporting event. It has two features; the non-electronic version which covers the mouth of wearer of the M Piece and the advertisement is manually changed. The second version is the fully electronic version in which the advertisement is changed through electronic communication from a preprogramed remote area. This allows the ads to be changed without having someone the physically change them. The M Piece is designed to cover the entire mouth rea so that the lips of the staffs lips can't be read by the opposing team. The advertisement of the sponsors can be seen during high viewing times or primes times which makes the advertising feature attractive to companies who are looking for prime time exposures.

I Darryl Cunningham Sr. have the only claim recorded to this invention called the M Piece.

Abstract of disclosure statement. The M Piece is simply a cover for a headset which is used mainly during sporting event. This Invention covers the mouth for the privacy of information while giving companies the ability to advertise and promote their brand through prime time exposure.

Sequence listing is not applicable due to nature of the invention.

The M Piece microphone cover is designed to cover the coach's mouth, while he is discussing game strategies with his coaches while using his headset Coaches have to hold up clipboards or other objects while talking to the coaches in the booths. The M Piece Microphone Cover will prevent them from having to place any object over their mouth while discussing the game strategies. The three inch by four inch cover will give them the protection that they will need from someone on the opposing team, who could be engaged in reading his lips during play calling decisions. The M Piece microphone cover secondly can be used to advertise company logos during the game which will generate revenues for that game. The M Piece can be interchanged throughout the game which will allow more sponsors to be included the revenue generating side of the game.
Furthermore the M Piece is not limited to protect coaches on the sidelines. It's uses reaches into Sports Announcers area or any area that uses any type or form of a headset

1. STATEMENT
MANUAL VERSION—ASSEMBLY INSTRUCTIONS
0001. Attach black metal bar frame to Acrylic Sign Holder with brackets and screws.
0002. Slide slotted metal bar frame posts over headset arm (by others) for a snug fit. Screw through post holes with black screws.
0003. Insert card stock logo in top slot of Acrylic Sign Holder.
0004. Try on headset with attached M Piece assembly. Adjust headset earphone and receiver for comfort.
ELECTRONIC VERSION—ASSEMBLY INSTRUCTIONS
0001. Attach black metal bar frame to Protective Case with brackets and screws.
0002. Slide slotted metal bar frame posts over headset arm (by others) for a snug fit. Screw through post holes with black screws.
0003. Turn on Flat Screen Monitor. Load digital logo and/or software onto Flat Screen Monitor.
0004. Insert Flat Screen Monitor into Protective Case.
0005. Try on headset with attached M Piece assembly. Adjust headset earphone and receiver for comfort.
